(19) United States
(12) Patent Application Publication
(10) Pub. No.: US 2008/0258641 A1
(43) Pub. Date: Oct. 23, 2008

(54) Power Supply For Semiconductor Light Emitting Device And Illuminating Device

(75) Inventors: Masao Nakagawa, Kanagawa (JP); Takemi Arita, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: Nakagawa Laboratories, Inc., Tokyo (JP)

(21) Appl. No.: 11/667,981

(22) PCT Filed: Oct. 20, 2005
(86) PCT No.: PCT/JP2005/019316

§ 371 Date: May 17, 2007

(30) Foreign Application Priority Data
Oct. 22, 2004 (JP) 2004-308011

(51) Int. Cl. H05B 41/16; H05B 41/36

(52) U.S. Cl. 315/246; 315/307

(57) ABSTRACT

The present invention provides a power supply for a semiconductor light emitting device capable of efficiently modulating and driving a current-driven semiconductor light emitting device. An LED 31, a switching element 32, which modulates and drives the LED 31, and an average current detector 12, which detects an average current flowing through the LED 31, are connected to a voltage source 11. When the LED 31 is modulated and driven by the switching element 32, blinking or light quantity of the LED is controlled, and the LED 31 then emits modulated light. The average current detector 12 detects an average light quantity emitted from the LED 31 and then controls the voltage source to output a voltage so that the average current flowing through the LED 31 can be almost constant. As a result, the average light quantity may be kept almost constant with or without modulation of the LED 31.

### TECHNICAL FIELD

The present invention relates to a power supply, which is used to control a current-driven semiconductor light emitting device such as a light emitting diode (LED), and an illuminating device using such power supply.

### BACKGROUND ART

FIG. 4 is a graph showing exemplary voltage-current characteristics of a conventional LED. In general, the voltage-current characteristic of LEDs consists in a forward characteristic of diodes. According to this characteristic, when a given threshold voltage is exceeded, even small changes in applied voltage causes large change in current value. Therefore, a lighting circuit for turning on a conventional LED is designed so that the current value cannot change against changes in output voltage and changes in forward characteristic of LEDs.

FIG. 5 is an example of a conventional LED driving circuit. In this drawing, 51 denotes a constant voltage source, 52 denotes a current-limiting resistor, 53 denotes an LED, and 54 denotes a constant current source. According to an LED lighting circuit shown in FIG. 5A, the current-limiting resistor 52 and the LED 53 are connected to the constant voltage source 51 in series. The voltage supplied from the constant voltage source 51 is constant. Therefore, a higher resistance of the current-limiting resistor 52 than that of the LED 53 allows the current flowing in the LED 53 to nearly conform to the voltage supplied from the constant voltage source 51 and the resistance of the 52. In this case, even though forward voltage characteristic of the LEDs varies, the current value can be kept almost constant. Moreover, even though the voltage of the constant voltage source 51 changes, the current value decided according to a relationship with the current-limiting resistor 52 does not change. Therefore, the value of the current flowing in the LED 53 may be kept almost constant. There is a problem with this method in that the power unnecessarily consumed by the current-limiting resistor 52 increases.

An LED lighting circuit shown in FIG. 5B has a structure where the LED 53 is connected to the constant current source 54. Use of the constant current source 54 allows the current flowing through the LED 53 to be constant. Patent Documents 1 and 2, for example, employ an LED lighting circuit using this constant current source.

However, since the LED lighting circuit using the constant current source 54 shown in FIG. 5B cannot change the current, it cannot be used for an application desiring to change (modulate) the light quantity of the LED 53. The LED lighting circuit shown in FIG. 5A can control the light quantity of the LED by changing the voltage. In this case, however, a large amount of power may be consumed unnecessarily, and there is no power supply that can control the light quantity of the LED efficiently.

In recent years, devices using such an LED as an illuminating device have been developed. Non-patent Document 1 discloses that illuminating light is modulated for data transmission. However, control of lighting and control of the light quantity of the illumination LED decreases the average light quantity emitted from the LED. This causes a problem that the illuminating light quantity when transmitting and not transmitting data varies.

Patent Document 1: Japanese Unexamined Patent Application Publication No. Hei 6-204564

Patent Document 2: Japanese Unexamined Patent Application Publication No. Hei 9-81211

Non-Patent Document 1: Toshihiko Komine, Yuichi Tanaka, Masao Nakagawa, “Fusion System for White Light LED Illumination Signal Transmission and Power Line Signal Transmission”, IEICE Report, The Institute of Electronics, Information, and Communication Engineers, vol. 101, no. 726, pp. 99-104, Mar. 12, 2002

### DISCLOSURE OF THE INVENTION

### [Problems to be Solved by the Invention]

In light of the problems described above, the present invention aims to provide a power supply for current-driven semiconductor LEDs, which allow the LED to be modulated and driven efficiently. Another objective of this invention is to provide an illuminating device using such a power supply for semiconductor LEDs.

### [Means for Solving the Problems]

According to an aspect of the present invention, a power supply for a semiconductor light emitting device capable of modulating and driving a current-driven semiconductor light emitting device is characterized in that the power supply includes: a voltage source capable of controlling an output voltage; and an average current detecting circuit, which detects an average current flowing through the semiconductor light emitting device; wherein the output voltage of the voltage source is controlled for the average current detected by the average current detecting circuit to be almost constant. The average current detecting circuit includes a current detecting resistor, an averaging circuit, and an amplifier. Note that the output voltage of the voltage source is desired to be controlled according to a maximum output voltage.

According to another aspect of the present invention, an illuminating device is characterized in that the illuminating device includes: the power supply for a semiconductor light emitting device described above; a current-driven semiconductor light emitting device, which emits light due to a current supplied from the power supply for a semiconductor light emitting device; and a modulating means, which controls a current provided to the semiconductor light emitting device in accordance with externally provided data. The output voltage is controlled so as for an average light quantity emitted from the semiconductor light emitting device to be almost constant even when the semiconductor light emitting device is modulated and driven by the modulating means.

### [Effects of the Invention]

According to the present invention, the average current flowing through the semiconductor light emitting device is detected, and the voltage source is controlled according to this average current. This allows almost constant current driving of the semiconductor light emitting device, thereby providing an unchanging average current against variance and aging of semiconductor light emitting devices. Even when the semiconductor light emitting device is modulated and driven, an almost constant current may be supplied to the semiconductor light emitting device by controlling the voltage source according to the average current. In addition, since the conventional current-limiting resistor is not used, there is an effect that the semiconductor light emitting device may be efficiently driven without unnecessarily consuming power.

Furthermore, when the semiconductor light emitting device is modulated and driven and when it is not, and irrespective to modulating method used for modulating and driving, an average current flowing through the semiconductor light emitting device may be kept almost constant. Accordingly, there is also an effect that fluctuation in illuminating light quantity may be kept almost constant even when the semiconductor light emitting device, for example, is used as an illuminating light source.

Moreover, by constituting an illuminating device using such power supply for semiconductor light emitting devices of the present invention, irregardless of the modulating means modulation-driving the semiconductor light emitting device, the average light quantity emitted from the semiconductor light emitting device may be controlled to be almost constant. For example, in the case of using the semiconductor light emitting device for illumination, there is an effect that the average illuminating light quantity is kept almost constant, not influencing the illuminating function even if the semiconductor light emitting device is modulated and driven and thereby modulating the illuminating light.

### BRIEF DESCRIPTION OF THE DRAWINGS

FIG. 1 shows a structure of an embodiment according to the present invention;

FIG. 2 is an illustration of an exemplary relationship between current flowing through an LED and voltage supplied by a voltage source;

FIG. 3 is an illustration of an application of the embodiment of the present invention;

FIG. 4 is a graph showing exemplary voltage-current characteristics of a typical LED; and

FIG. 5 is an illustration of an exemplary typical LED lighting circuit.

### BEST MODE FOR CARRYING OUT THE INVENTION

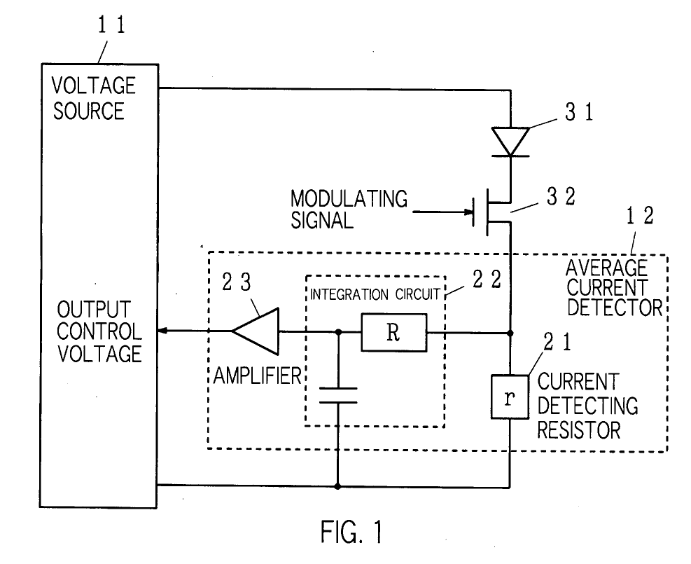

FIG. 1 shows a structure of an embodiment according to the present invention. In this drawing, 11 denotes a voltage source; 12 denotes an average current detector; 21 denotes a current detecting resistor; 22 denotes an integration circuit; 23 denotes an amplifier; 31 denotes an LED; and 32 denotes a switching element. A semiconductor LED power supply shown in FIG. 1 is constituted by the voltage source 11 and the average current detector 12, and have the LED 31 and the switching element 32 connected thereto in series. The LED 31 may be turned on using a high electric power for illumination, for example. The switching element 32 is constituted by a FET or a transistor, for example. The current supplied to the LED 31 is controlled based on an information signal supplied to the base of the FET or the transistor. This changes the light quantity (including blinking) of the LED 31, by which light emitted from the LED 31 is modulated. If rate of this modulation is high, variation of light quantity (or blinking) is undetectable by the human eye, and transmission of information while illuminating is possible. Note that there may be one or more of the LED 31. A current-driven semiconductor light emitting device other than LEDs is also available.

The voltage source 11 is a voltage source allowing external control of voltages, and in this case, an output voltage from the voltage source 11 is controlled according to a voltage output from the average current detector 12. In addition, the voltage source 11 has a maximum output voltage controlling function so that the voltage does not increase endlessly.

The average current detector 12 detects an average current flowing through the LED 31, and outputs a control voltage to the voltage source 11. In this case, the average current detector 12 is constituted by the current detecting resistor 21, the integration circuit 22, and the amplifier 23.

The current detecting resistor 21 is connected to the LED 31 in series, and is provided to detect current flowing through the LED 31. Acquisition of voltages at both ends of the current detecting resistor 21 allows indirect acquisition of the current flowing through the LED 31. Note that since resistance of the current detecting resistor 21 should allow acquisition of the voltages at both ends, it may be smaller by far than the conventional current detecting resistor. Power consumption of the current detecting resistor 21 may be controlled to be less by far than power consumption of the conventional current detecting resistor.

The integration circuit 22 is provided to average out the voltages retrieved from the current detecting resistor 21. The current flowing through the LED 31 is controlled by the switching element 32 to be changed to a higher speed. This integration circuit 22 is provided to generate a voltage corresponding to the average current flowing through the LED so that the voltage of the voltage source 11 does not change to keep up with such change in high speed current. The integration circuit 22 may be constituted by a common integration circuit including a resistor R and a capacitor C, as shown in FIG. 1, for example. Not limited to an R-C circuit, any integration (smoothing) circuit may naturally be used.

The amplifier 23 is provided to step up a voltage, which is acquired from both ends of the current detecting resistor 21 and smoothed by the integration circuit 22, so as to control the voltage source 11. Output of the amplifier 23 is the control voltage of the voltage source 11.

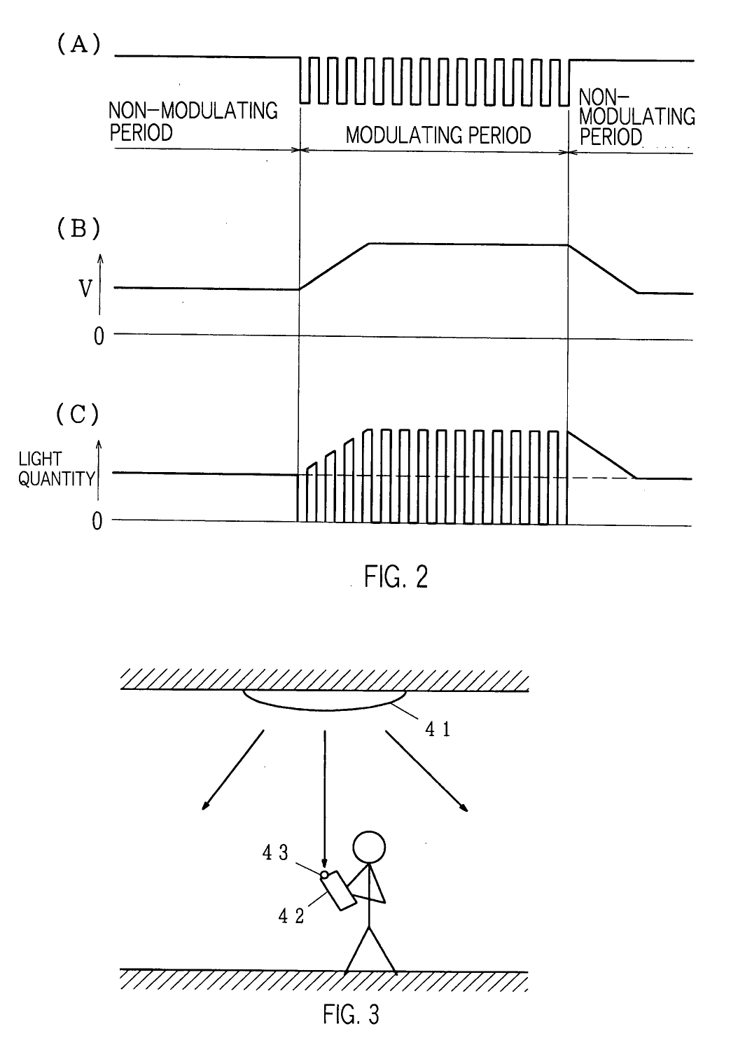

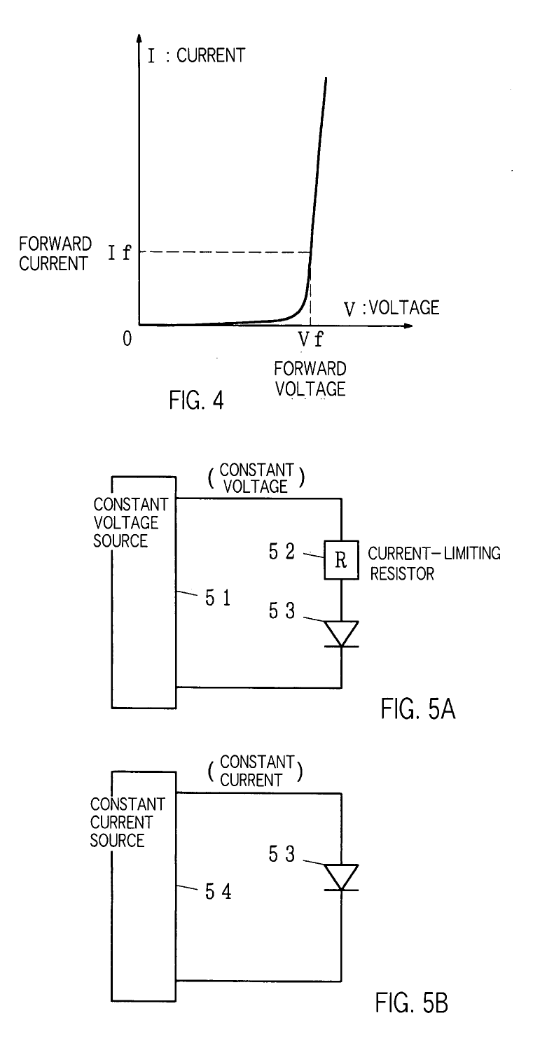

Next, a synopsis of the behavior according to the embodiment of the present invention is described. FIG. 2 is an illustration of an exemplary relationship between current flowing through an LED and voltage supplied by a voltage source. While the LED 31 is lighting continuously, an almost constant current flows through the LED 31, the average current detector 12 inputs an almost constant detection result as a control voltage to the voltage source 11, and the voltage source 11 outputs an almost constant voltage suitable to the lighting of the LED 31. This behavior is shown as a non-modulating period in FIG. 2.

When a modulating signal is input to the switching element 32, the switching element 32 controls the current supplied to the LED 31 to turn on or off in accordance with the modulating signal, or controls the amount of current. As a result, the LED blinks or the light quantity is changed in accordance with the modulating signal, and modulated light is emitted from the LED 31.

Furthermore, the change in the amount of current supplied to the LED 31 is detected by the average current detector 12. At this time, the current flowing through the LED 31 is less than current during normal lighting by an amount for lighting being controlled to be off or dark. Accordingly, the average current decreases while the LED 31 is modulated and driven. When the average current flowing through the LED 31 decreases, the average current detector 12 provides a control voltage corresponding to that average current to the voltage source 11, controlling the voltage source 11 to raise the output voltage. At this time, the output voltage of the voltage source 11 gradually increases in accordance with the time constant for the integration circuit 22 in the average current detector 12. According to such control, the output voltage of the voltage source 11 gradually increases as a modulating period starts, as shown in FIG. 2B.

The amount of current while the LED 31 is lighting also increases by raising the output voltage of the voltage source 11 in this manner, thereby increasing the averaged amount of current. The output voltage of the voltage source 11 is then increased until it reaches an average amount of current almost equal to the average current flowing the non-modulating period. As such, it is controlled so as to provide the same average current even during the modulated period of FIG. 2 as current flowing during the non-modulating period.

A case of inputting pulses at constant intervals as modulated signals is shown in FIG. 2; however, data actually transmitted does not often include Os and is evenly lined up. Therefore, when blinking or amount of lighting of the LED 31 is controlled by a modulated signal according to data to be transmitted, fluctuation of blinking intervals or amount of light of the LED 31 also changes according to the data, thereby changing the average current flowing through the LED 31 according to the data. Even in such a case, the control voltage for the voltage source 11 is changed according to the changing average current, and thus the output voltage of the voltage source 11 always changes during the modulating period.

Since the LED 31 is in a lighting state when the modulating period ends and returns to a steady state, the average current increases more than in the modulating period. The increase in the average current is detected by the average current detector 12 to control the voltage source 11 so as to lower the output voltage. As a result, the output voltage of the voltage source 11 decreases, and the current flowing through the LED 31 decreases. This allows the output voltage of the voltage source 11 to return to the steady state, and the current flowing through the LED 31 to also return to the steady state.

In this manner, since the output voltage of the voltage source 11 is controlled in accordance with the average current flowing through the LED 31, the average light quantity of the LED 31 can be controlled to be almost constant during the non-modulating period in the steady state and the modulating period.

Note that when current stops flowing through the LED 31 due to damage or disconnection of the LED 31, it is possible for the average current to become 0 or extremely small. In such a case, when the average current is detected by the average current detector 12 to control the output voltage of the voltage source 11 in attempt to increase the average current, the output voltage of the voltage source 11 may increase excessively. In response to such a case, it is preferable to keep the output voltage of the voltage source 11 from increasing higher than a predetermined voltage.

FIG. 3 is an illustration of an application according to the embodiment of the present invention. In this drawing, 41 denotes lighting; 42 denotes a terminal unit; and 43 denotes a light receiving part. The lighting 41 includes the configuration according to the embodiment of the present invention shown in FIG. 1, and emitted light from one or a plurality of LEDs 31 may be used as illuminating light.

Furthermore, the current supplied to the LED 31 is modulated by the switching element 32 shown in FIG. 1 according to the data, thereby also modulating the light emitted from the LED 31. This modulated light is received by the light receiving part 43 of the terminal unit 42, converted to an electronic signal, and modulated, allowing the terminal unit 42 to receive the data transmitted from the LED 31. This allows communication using the emitted light from the LED 31. The emitted light of the LED 31 is available as illuminating light in the aforementioned manner.

Blinking or light quantity of the emitted light of the LED 31 is changed due to the LED 31 being modulated and driven. However, if the modulation rate is higher than several MHz, for example, the change in blinking or light quantity of the LED 31 is not humanly visible nor do problems such as flickering occur. In this case, the average light quantity decreases due to modulating and driving of the LED 31. With the present invention, by the average current detector 12 controlling the voltage source 11y, the average current flowing through the LED 31 is stabilized, thereby keeping an almost constant average light quantity emitted from the LED 31. At this time, through selection of a controlling period (reciprocal of time constant of the integration circuit 22) for controlling the output voltage of the voltage source 11 by the average current detector 12 much longer than a fundamental period for modulation according to data (e.g., frequency of several MHz) and substantially smaller than a period (dozens of Hz) or a frequency of several kHz with which light from the LED 31 is seen as flickering, fluctuation in light quantity of the LED 31 due to control of the voltage source 11 may be suppressed to a degree that is almost humanly undetectable.

As a result, even when light emitted from the LED 31 is used for illumination, data transmission via the illuminating light may be attained by modulating and driving the LED 31. Furthermore, fluctuation in light quantity due to modulating and driving the LED 31 may be suppressed, thereby providing a constant illuminating light quantity.

1. A power supply for a semiconductor light emitting device capable of modulating and driving a current-driven semiconductor light emitting device; said power supply comprising:
a voltage source capable of controlling an output voltage; and
an average current detecting circuit, which detects an average current flowing through the semiconductor light emitting device; wherein the output voltage of the voltage source is controlled for the average current detected by the average current detecting circuit to be almost constant.

2. The power supply for the semiconductor light emitting device of claim 1, wherein the output voltage of the voltage source is controlled according to a maximum output voltage.

3. The power supply for the semiconductor light emitting device of claim 1, wherein the average current detecting circuit comprises a current detecting resistor, an averaging circuit, and an amplifier.

4. The power supply for the semiconductor light emitting device of claim 1, wherein the semiconductor light emitting device is an LED.

5. An illuminating device, comprising:
the power supply for a semiconductor light emitting device of claim 1;
a current-driven semiconductor light emitting device, which emits light due to a current supplied from the power supply for a semiconductor light emitting device; and
a modulating means, which controls a current provided to the semiconductor light emitting device in accordance with externally provided data.

6. The illuminating device of claim 5, wherein the power supply for a semiconductor light emitting device controls the output voltage so as for an average light quantity emitted from the semiconductor light emitting device to be almost constant even when the semiconductor light emitting device is modulated and driven by the modulating means.
